(19) United States
(12) Patent Application Publication
(10) Pub. No.: US 2026/0070626 A1
(43) Pub. Date: Mar. 12, 2026

(54) SSR1 AUTOCYCLE DUAL MOTOR HYBRID

(71) Applicant: Brisbin Marvin Skiles, Appalachacola, FL (US)

(72) Inventor: Brisbin Marvin Skiles, Appalachacola, FL (US)

(21) Appl. No.: 18/827,412

(22) Filed: Sep. 6, 2024

(51) Int. Cl. B62K 13/06; B62J 6/022; B62J 6/04; B62J 17/086; B62J 43/16; B62K 13/08; B62K 23/02; B62M 7/02; B62M 9/121; F02B 75/02

(52) U.S. Cl. CPC B62K 13/06; B62J 6/022; B62J 6/04; B62J 17/086; B62J 43/16; B62K 13/08; B62K 23/02; B62M 7/02; B62M 9/121; F02B 75/02; F02B 2075/027

(57) ABSTRACT

A vehicle having a framework; at least two or more wheels, the at least two or more wheels are into engagement with the framework; a seat engaged with the framework; a four (4) stroke engine; an electric drive system, wherein the electric drive system is configured to propel the vehicle by itself or in tandem with the four (4) stroke engine; at least one or more batteries that is configured to provide power to the electric drive system; at least one or more solar panels, and wherein the solar power device is configured to power the electric drive system and/or charge the at least one or more batteries. The SSR1 Rocket Autocycle includes a 100-amp alternator which is connected to a Drivetrain and charges all battery components on the vehicle when needed and in motion.

### CROSS-REFERENCE TO RELATED APPLICATIONS

Not applicable.

### RELATED CO-PENDING U.S. PATENT APPLICATIONS

Not applicable.

### INCORPORATION BY REFERENCE OF SEQUENCE LISTING PROVIDED AS ATEXT FILE

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### FIELD OF THE INVENTION

One or more embodiments of the invention generally relate to transportation devices. More particularly, certain embodiments of the invention relate to less, equal or greater than four (4) wheel autocycle devices.

### BACKGROUND OF THE RELEVANT PRIOR ART

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that a conventional four-stroke (four-cycle) engine or internal combustion (IC) engine in which a piston completes four separate strokes while turning a crankshaft. A stroke may refer to a full travel of the piston along a cylinder, in either direction. Most modern internal combustion engines are 4-stroke engines that may run on gasoline or diesel fuel. Four (4) stroke engines have four valves that pistons may go through four events to complete one 4-stroke cycle. A piston motion including upward or downward may be defined as an event. After the four events, the cycle is complete and ready to restart.

A sociable or buddy bike or side by side bicycle is a bicycle that may support two riders who sit next to one another, in contrast to a tandem bicycle, where the riders sit front and back. A side-by-side bicycle is needed so two cyclists may speak with each other, unlike on the tandem.

Solar-powered vehicles are known in the art. Typical solar-powered vehicles may employ photovoltaic cells to convert energy from the sun into electric energy. Such solar-powered vehicles have been mainly impractical for day-to-day transportation. There may be a number of factors that account for this impracticality. For example, power from a solar array is limited by the size of the photovoltaic array and the surface area of the photovoltaic array that is exposed to sunlight. A large vehicle requires more energy to move. While batteries may be employed to store energy from the photovoltaic cells, the battery also adds to the overall weight of the vehicle. Photovoltaic panels are heavy. In order to be useful, the energy supplied by a photovoltaic panel must be sufficient to offset the increased weight of the vehicle as a result of the addition of the panel. A solar-powered vehicle that overcomes limitations in the art is needed that provides a practical vehicle for day-to-day transportation.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an illustration of an exemplary autocycle device or Skiles Solutions Rocket #1 (SSR1), in accordance with an embodiment of the present invention;

FIG. 2 is a back view an exemplary autocycle device or SSR1 Rocket, in accordance with an embodiment of the present invention;

FIG. 3 is a bottom view of an exemplary autocycle device or SSR1 Rocket, in accordance with an embodiment of the present invention; and

FIG. 4 is an under-frame view of an exemplary autocycle device or SSR1 Rocket, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settled law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P. A.I. 2010) Depending on its usage, the word “substantially” can denote either language of approximation or language of magnitude. Deering Precision Instruments, L.L. C.v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, the term ‘substantially’ is well recognized in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of Claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%”includes the “about 10%”endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. § 112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C. P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,”do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” include the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late-stage user(s) as opposed to early-stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of. or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising” And “contain” and variations of them-Such terms are open-ended and mean “including but not limited to”. When employed in the appended claims, this term does not foreclose additional structure or steps. Consider a claim that recites: “A memory controller comprising a system cache.” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

All terms of exemplary language (e.g., including, without limitation, “such as”, “like”, “for example”, “for instance”, “similar to”, etc.) are not exclusive of any other, potentially, unrelated, types of examples; thus, implicitly mean “by way of example, and not limitation . . . ”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” and “consisting of” limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the present invention which claims an embodiment “consisting essentially of” or “consisting of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of,” where one of these three terms is used herein, the disclosed and claimed subject matter may include the use of either of the other two terms. Thus, in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Moreover, any claim limitation phrased in functional limitation terms covered by 35 USC § 112(6) (post AIA 112(f)) which has a preamble invoking the closed terms “consisting of,” or “consisting essentially of,” should be understood to mean that the corresponding structure(s) disclosed herein define the exact metes and bounds of what the so claimed invention embodiment(s) consists of, or consisting essentially of, to the exclusion of any other elements which do not materially affect the intended purpose of the so claimed embodiment(s).

Devices or system modules that are in at least general communication with each other need not be in continuous communication with each other, unless expressly specified otherwise. In addition, devices or system modules that are in at least general communication with each other may communicate directly or indirectly through one or more intermediaries. Moreover, it is understood that any system components described or named in any embodiment or claimed herein may be grouped or sub-grouped (and accordingly implicitly renamed) in any combination or sub-combination as those skilled in the art can imagine as suitable for the particular application, and still be within the scope and spirit of the claimed embodiments of the present invention. For an example of what this means, if the invention was a controller of a motor and a valve and the embodiments and claims articulated those components as being separately grouped and connected, applying the foregoing would mean that such an invention and claims would also implicitly cover the valve being grouped inside the motor and the controller being a remote controller with no direct physical connection to the motor or internalized valve, as such the claimed invention is contemplated to cover all ways of grouping and/or adding of intermediate components or systems that still substantially achieve the intended result of the invention.

A description of an embodiment with several components in communication with each other does not imply that all such components are required. On the contrary a variety of optional components is described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

In some embodiments of the present invention and variations thereof, relate to autocycle devices comprising, without limitation, a “motorcycle style” framework, a plurality of wheels, gasoline/LPG engine, power source, rechargeable power storage and power source controller.

The present invention will now be described in detail with reference to embodiments thereof as illustrated in the accompanying drawings.

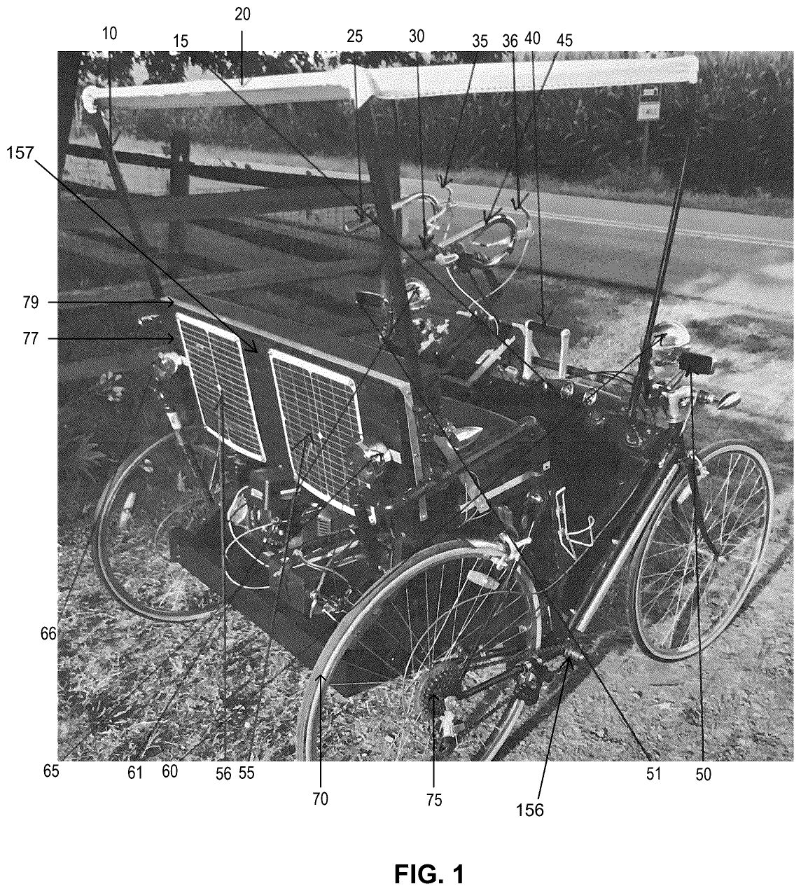

FIG. 1 is an illustration of an exemplary autocycle device or Skiles Solutions Rocket #1 (SSR1), in accordance with an embodiment of the present invention. In one embodiment of the present invention, autocycle device may incorporate a “motorcycle style” framework, as shown, including without limitation, to all intents and purposes, four-wheels, three wheels, five wheels, etc. Autocycle device may comprise, without limitation, toll bar 10, voltage, oil pressure and temperature gauges 15, removable convertible top 20, fuel throttle control tool 25, electric throttle speed control tool 30, caliper brake front 35 and rear 36, five speed transmission shifter 40, handlebar steering 45, rear view side mirrors left 50 and right 51, solar panels 55 56 at a back of vehicle seat 77, backing plate 157, right and left head lamps 60 61, right and left tail lamps 65 66, wheels 70, and transmission derailer 75. Head lamps 60 61 and tail lamps 65 66 may include, without limitation, turn signals, brake lights and/or running lights. Wheels 70 may include without limitation bicycle or motorcycle type wheels. Transmission derailer 75 may include without limitation a 5-speed, 4-speed or 3-speed train drive transmission. Fuel may include without limitation gasoline and/or Liquid Petroleum (LP/LPG/LPF) fuel. Solar panels 55 56 are configured to be adjustable degree angle solar panels and may include without limitation at least one (1) or more 4-watts to 200-watts solar panels. Solar panels 55 56 have a hinged backing plate 157 that may be lifted and adjusted approximately 90 degrees, according to the sun's relative angle in the sky. In some embodiments, autocycle device or SSR1 Rocket utilizes, without limitation, a single or dual motor, hybrid system using both an ecofriendly two (2), four (4), or five (5)-six (6) stroke gasoline/LPG engine which runs on both conventional gasoline and or liquid petroleum fuel. The four-stroke “ecofriendly” gasoline engine is approved for use in CA and other EPA restrictive states. The carburetor on the engine is dual purpose for either gasoline or LP fuel (Liquid Petroleum Fuel). The four-stroke engine has a shutoff/turnoff valve which turns off the gasoline and allows the LP fuel to be introduced into the carburetor. A separate LP fuel tank with regulator is placed and secured in the rear of the SSR1 Rocket frame. Liquid Petroleum Fuel may burn extremely efficiently and produces almost “0” emissions. Throttle control tool 25 controlling the flow of fuel or power to the engine.

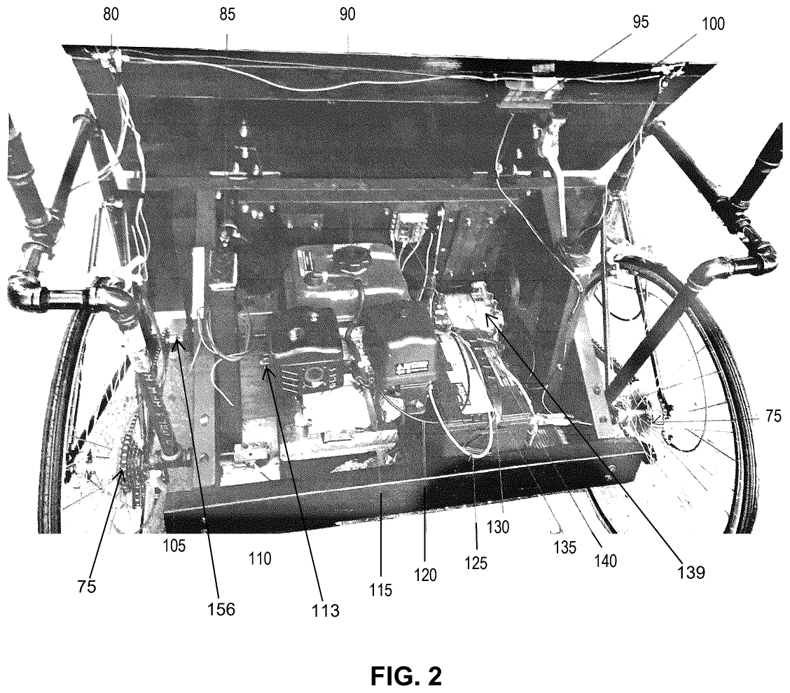

FIG. 2 is a back view of an exemplary autocycle device or SSR1 Rocket, in accordance with an embodiment of the present invention. In one embodiment of the present invention, autocycle device may comprise, without limitation, wiring harness 80, key electric start solenoid 85, eco-friendly four-stroke engine (e.g. 4-10 HP, etc.) 90, solar power controller 95, variable degree solar panel stand 100, drive shaft chain sprocket 105, chain drive centrifugal clutch 110, gasoline/propane carburetor 115, choke cable 120, throttle cable 125, battery 130, jackshaft 156, electrical fuse box 135, and charging alternator 140. Battery 130 may include a 12-volt or more battery and charging alternator 140. Charging alternator 140 may include a 200-amps to 100-amps or less charging alternator. Electrical fuse box may provide power to various features such as, but not limited to, headlamps, brake lights, turn signals, and running lights. Jackshaft 156 transfers power from the motors to drive shaft wheels more efficiently. Jackshaft 156 is connected to the 2,000-watt DC motor 150 under the seating area via chain and sprocket drive with a “freewheeling” gear assembly. This allows the gasoline engine and/or DC motor to run independently of each other or in unison when desired by the operator. Also attached to Jackshaft 156 is at least 100-amp alternator 140 using a “V Belt” Pulley System 139 which operates and charges the battery packs whenever in motion and needed using a built-in voltage regulator.

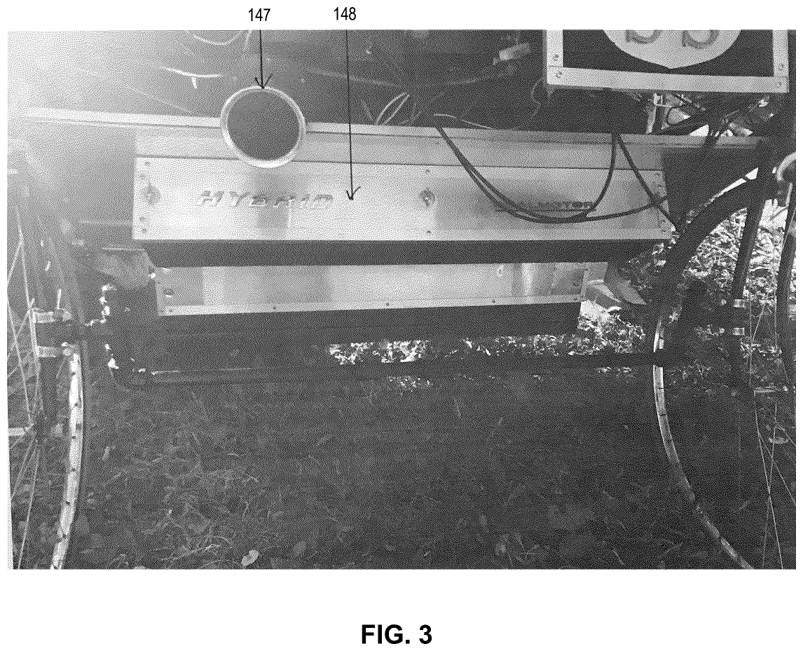

FIG. 3 is a bottom view of an exemplary autocycle device or SSR1 Rocket, in accordance with an embodiment of the present invention. In one embodiment of the present invention, four-wheel autocycle device may comprise without limitation horn 147 and power pack box 148. Power pack box 148 may house without limitation, a power pack having one or more batteries. For example, power pack box 148 may house a power pack including, without limitation, at least four 12-volt DC batteries wired together to produce forty-eight (48) volts needed for a 2,000-watt DC motor. A 12-volt battery 130 located in the rear area of the SSR1 Rocket (resulting in better weight distribution) operates the gasoline/LP 4-stroke motor's ignition and lighting features such as, without limitation, headlamps, brake lights, turn signals and running lights, radio, phone jack, etc. The 48-volt battery pack and 12-volt auto battery 130 may be constantly being charged when the autocycle is in motion with 100-amp alternator 140 and/or when solar panels 55 56 are in direct sunlight exposure.

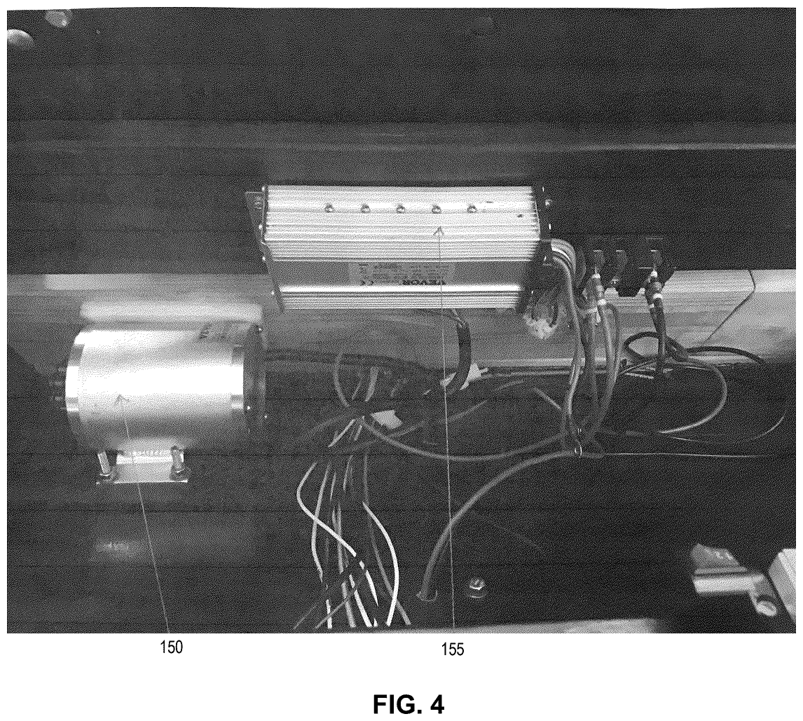

FIG. 4 is an under-frame view of an exemplary autocycle or SSR1 Rocket device, in accordance with an embodiment of the present invention. In one embodiment of the present invention, autocycle device may incorporate, without limitation a motor 150 and power controller 155. Motor implement 150 may include without limitation a 48-volt 2000-watt DC motor system, which may be used separately to propel the vehicle or in unison with the 4-stroke gasoline/LP engine. The fuel/gasoline throttle control tool 25 is utilized in a twisting motion as on any conventional motorcycle of moped. Throttle control tool 25 location is on a left-hand side of handlebars 45 as shown. DC electric speed/motor control tool 30 is utilized in the same manner when needed. Electric Speed/Motor control tool 30 has its own “key lock” incorporated in the handle for security. Electric Speed/Motor control tool 30 is located on the right-hand side of the handlebars as shown. Power controller 155 may include without limitation a 48-volt DC power controller. Power controller 155 is connected to Speed/Motor Control 30 and 48-volt power pack 148. The combination may control the speed of the autocycle when in electric drive mode set by the operator. The electric drive system uses 48-volt power pack 148 that being connected to Speed/Motor Control 30 and power controller 155 powers the 2,000-watt DC motor.

In some embodiments, DC electric drive system may be constantly charged when in the sun with solar panels 55, 56 that are attached to the back of the vehicle seat. The solar panels are adjustable to the direction of the sun's rays according to the time of day and exposure. The Solar Panels are attached to backing plate 157 which is hinged allowing at least 90 degrees manual adjustment via a “ratcheted device” under backing plate 157. This allows optimum access to the sun's rays improving solar charging throughout the day towards the sun's direction. In additional embodiments, the autocycle device or SSR1 Rocket electric drive system when in motion utilizing a 100-amp alternator attached to a drivetrain 113 via a V-belt pulley system 139. The drivetrain 113 of the SSR1 Rocket may utilize Jackshaft connection 156 which connects both the 4-stroke gasoline/LP engine and the 2,000-watt DC motor system. These in turn use a “freewheeling” sprocket chain drive which may power the autocycle each separately or in unison depending upon the operator's desire. Connected to Jackshaft 156 is 100-amp alternator 140. The alternator uses “V-Belt” pulley system 139. 100-amp charging alternator 140 is connected to the “Jackshaft” 156 via a “V Belt” Pulley System 139. This turns the alternator and charges the electrical system whenever the autocycle is in motion. The charging process is calibrated by an internal voltage regulator within the alternator.

In some embodiments, 2,000-watt DC electric motor 50 is connected to the drivetrain via a sprocket and chain drive. The 2,000-watt electric motor has a “freewheeling” sprocket and chain connection so as to enable the gasoline/LP fuel 4-stroke engine to operate on its own and/or separately when in use without the encumbrance of the electric motor and the connecting shaft resulting in better efficiency.

In other embodiments, 2,000-watt electric motor 50 and 4-stroke gasoline/LP engine 90 are connected to “Jackshaft” 156 via the chain and sprocket drive using “freewheeling” sprockets which may allow both “separate” and “in unison” drive feature operation and enables “coasting”down hills to further enhance the MPG features.

In further embodiments, 48-volt power pack 148 and 12-volt auto battery 130 may be charged by solar panels 55, 56 when exposed to the sun's rays. The autocycle device or SSR1 Electric Drive System power pack 148 and 12-volt auto battery 130 may constantly recharge when in motion utilizing 100-amp alternator 140 attached to the Drivetrain 113 via “Jackshaft” 156 with the V-belt pulley system as previously described when needed.

Utilizing the two direct charging systems and capabilities results in independence from a “plug-in” charger from an outside source (e.g. “charging station”). In further embodiments, a plug-in charger may be installed in the SSR1 Rocket if the need arises resulting from long term parking inside and out of solar exposures. When using the two drive systems of travelling may exceed 150-200 MPG in fuel consumption efficiency. This may result in the highest MPG for a manufactured market vehicle available for sale to the public.

The operator may decide to use one system or both drive systems in unison or separately depending on the fuel availability and the power of operation required such as, without limitation, climbing a hill, increasing speed, etc.

The SSR1 Rocket, being considered a LSV (low speed vehicle)—Florida section 320-01 (41), Florida Statutes may be registered, titled, and insured upon inspection with the appropriate and necessary street legal equipment. (headlamps, front, and rear turn signals, stop lamps, tail lamps, reflectors—red—one on each side and rear placement, exterior mirrors, parking brake, wind shield, seat belts and a VIN—(vehicle identification number). The SSR1 Rocket is street legal in the state of Florida and possibly many other states which have similar requirements. The SSR1 Rocket is equipped with all the above requirements.

The charging systems used in the SSR1 Rocket are self-regulating with a solar voltage controller attached under the seat. The solar panels may be manually adjusted by an operator according to the sun's direction. The 100-amp alternator has its own voltage regulator internally and thus prevents overcharging and charging when needed, especially at night when the headlamps, taillamps, etc. are used.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied. Such computers referenced and/or described in this disclosure may be any kind of computer, either general purpose, or some specific purpose computer such as, but not limited to, a workstation, a mainframe, GPU, ASIC, etc. The programs may be written in C, or Java, Brew or any other suitable programming language. The programs may be resident on a storage medium, e.g., magnetic or optical, e.g., without limitation, the computer hard drive, a removable disk or media such as, without limitation, a memory stick or SD media, or other removable medium. The programs may also be run over a network, for example, with a server or other machine sending signals to the local machine, which allows the local machine to carry out the operations described herein.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

It is necessary to understand the importance and viability of the SSR 1 Rocket Hybrid Autocycle at this time. It has multiple uses for inner city and urban customers.
Ease of operation in city or town streets.
Parking accessibility
Extremely low cost of use with the estimated highest MPG fuel mileage available in a commercially available vehicle. (TBD)
Low-cost maintenance on an efficient, ecofriendly 4-stroke air-cooled motor (needs no winterizing, antifreeze, etc.
The SSR 1 Rocket runs on both regular gasoline or LP (Liquid Petroleum) whichever is available.
The Rocket Autocycle may be driven with the self-charging solar 2,000 watt DC power motor—which uses no fuel and charges itself while running or parked in the sun's exposure.
No Charging Stations Needed.
The SSR1 Rocket Autocycle may also be used by rural customers who require a way to get to town for groceries, prescriptions or just a very inexpensive way to travel to and from home.
The “Rollbar Mayopy Convertible Top” may be equipped with a plastic door and windshield package to prevent rain and weather from entering the seating area. (similar to golf cart designs presently in use)
Additionally, the SSR1 Rocket Autocycle Hybrid may and will be equipped with rear shock absorbers and “Springer front fork” as was done in early motorcycle productions.
One huge advantage of the SSR 1 Rocket Autocycle is: that it may be driven by anyone or any age group with a valid driver's license.
NO special motorcycle license or permit may be needed, and NO motorcycle test is required.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC § 112 (1), all claims must be supported by sufficient disclosure in the present patent specification, and any material known to those skilled in the art need not be explicitly disclosed. However, 35 USC § 112 (6) requires that structures corresponding to functional limitations interpreted under 35 USC § 112 (6) must be explicitly disclosed in the patent specification. Moreover, the USPTO's Examination policy of initially treating and searching prior art under the broadest interpretation of a “mean for” or “steps for” claim limitation implies that the broadest initial search on 35 USC § 112(6) (post AIA 112(f)) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC § 112(6) (post AIA 112(f)) when such corresponding structures are not explicitly disclosed in the foregoing patent specification. Therefore, for any invention element(s)/structure(s) corresponding to functional claim limitation(s), in the below claims interpreted under 35 USC § 112(6) (post AIA 112(f)), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claim's construction proceedings and/or examination of patent allowability properly identify and incorporate only the portions of each of these documents discovered during the broadest interpretation search of 35 USC § 112(6) (post AIA 112(f)) limitation, which exist in at least one of the patents and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserves its right to later amend the present application to explicitly include citations to such documents and/or explicitly include the functionally corresponding structures which were incorporated by reference above.

Thus, for any invention element(s)/structure(s) corresponding to functional claim limitation(s), in the below claims, that are interpreted under 35 USC § 112(6) (post AIA 112(f)), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC § 112 (6). Applicant(s) note that all the identified documents above which are incorporated by reference to satisfy 35 USC § 112 (6) necessarily have a filing and/or publication date prior to that of the instant application, and thus are valid prior documents to incorporated by reference in the instant application.

Having fully described at least one embodiment of the present invention, other equivalent or alternative methods of implementing the autocycle device according to the present invention will be apparent to those skilled in the art. Various aspects of the invention have been described above by way of illustration, and the specific embodiments disclosed are not intended to limit the invention to the particular forms disclosed. The particular implementation of the autocycle device may vary depending upon the particular context or application. By way of example, and not limitation, the autocycle device described in the foregoing were principally directed to human transportation implementations; however, similar techniques may instead be applied to baggage, objects, etc., which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

Only those claims which employ the words “means for” or “steps for” are to be interpreted under 35 USC 112, sixth paragraph (pre-AIA) or 35 USC 112(f) post-AIA. Otherwise, no limitations from the specification are to be read into any claims, unless those limitations are expressly included in the claims.

What is claimed is:

1. A vehicle comprising:
a framework;
at least two or more wheels into engagement with said framework, wherein said wheels comprise at least one of a bicycle and motorcycle type wheels;
a seat engaged with said framework;
a convertible top, wherein said convertible top is into engagement with said framework, and wherein said convertible top is removable from said framework;
at least two handlebars, wherein said handlebars are configured to be operable for steering said device;
a four (4) stroke engine, wherein said four (4) stroke engine is configured to run on conventional gasoline and/or liquid petroleum fuel (LPF/LPG);
an electric drive system, wherein said electric drive system is configured to propel said vehicle by itself or in tandem with said four (4) stroke engine, and wherein said electric drive system comprises at least one motor;
at least one or more batteries, wherein said at least one or more batteries is/are configured to provide power to electrical/electronic parts of said vehicle, and wherein said at least one or more batteries comprise(s) rechargeable batteries;
a solar power device, wherein said solar power device comprises at least one or more solar panels that is configured to power said electric drive system and/or charge said at least one or more batteries; and
a backing plate, said backing plate comprises an adjustable stand for the solar panels, wherein said adjustable solar panel stand is configured to allow access to the sun's rays improving solar charging of the batteries.

2. The vehicle of claim 1, further comprising a fuel throttle control tool, wherein said fuel throttle control tool is configured to control a flow of fuel or power to said four (4) stroke engine.

3. The vehicle of claim 2, further comprising an electric speed/motor control tool, wherein said electric speed/motor control tool is configured to control a speed of said electric drive system.

4. A vehicle comprising:
a framework;
at least two or more wheels, wherein said at least two or more wheels are engaged with said framework;
a seat engaged with said framework;
a convertible top into engagement with said framework, wherein said convertible top is removable from said framework;
a four (4) stroke engine, wherein said four (4) stroke engine is configured to run on at least one of a conventional gasoline and liquid petroleum fuel (LPF/LPG);
a fuel throttle control tool, wherein said fuel throttle control tool is configured to control a flow of fuel or power to said four (4) stroke engine;
an electric drive system;
at least one or more rechargeable batteries that is configured to provide power to electrical and/or electronic parts of said vehicle; and
a solar power device, wherein said solar power device is configured to provide power said electric drive system and/or charge said at least one or more rechargeable batteries.

5. The vehicle of claim 4, further comprising a transmission shifter.

6. The vehicle of claim 4, further comprising:
at least one or more head lamps; and
at least one or more tail lamps.

7. The vehicle of claim 4, further comprising a backing plate, said backing plate comprises an adjustable stand for the solar panels, wherein said adjustable solar panel stand is configured to allow access to the sun's rays improving solar charging of the batteries.

8. The vehicle of claim 4, further comprising a charging alternator, wherein said charging alternator is configured to charge said battery.

9. The vehicle of claim 4, further comprising a jackshaft.

10. The vehicle of claim 4, further comprising a power pack box.

11. The vehicle of claim 4, further comprising a key electric start solenoid.

12. The vehicle of claim 4, further comprising an electric speed/motor control tool, wherein said electric speed/motor control tool is configured to control a speed of said electric drive system.

13. A vehicle comprising:
a framework;
at least two or more wheels, said at least two or more wheels are into engagement with said framework;
a seat engaged with said framework;
a four (4) stroke engine, wherein said four (4) stroke engine is configured to run on conventional gasoline and/or liquid petroleum fuel (LPF/LPG);
an electric drive system, wherein said electric drive system is configured to propel said vehicle by itself or in tandem with said four (4) stroke engine, and wherein said electric drive system comprises at least one motor;
at least one or more batteries that is configured to provide power to said electric drive system; and
a solar power device, wherein said solar power device comprises at least one or more solar panels, and wherein said solar power device is configured to power said electric drive system and/or charge said at least one or more batteries.

14. The vehicle of claim 13, further comprising a fuel throttle control tool, wherein said fuel throttle control tool is configured to control a flow of fuel or power to said four (4) stroke engine.

15. The vehicle of claim 14, further comprising an electric speed/motor control tool, wherein said electric speed/motor control tool is configured to control a speed of said electric drive system.

16. The vehicle of claim 13, further comprising a backing plate, wherein said backing plate comprises an adjustable solar panel stand.

17. The vehicle of claim 13, further comprising:
a transmission shifter; and
a transmission derailer.

18. The vehicle of claim 13, further comprising:
a charging alternator; and
a key electric start solenoid.

19. The vehicle of claim 13, further comprising:
at least one or more head lamps; and
at least one or more tail lamps.

20. The vehicle of claim 13, further comprising a jackshaft.
